(19) United States
(12) Patent Application Publication
(10) Pub. No.: US 2014/0267679 A1
(43) Pub. Date: Sep. 18, 2014

(54) INDENTATION HARDNESS TEST SYSTEM HAVING AN AUTOLEARNING SHADING CORRECTOR

(71) Applicant: LECO CORPORATION, St. Joseph, MI (US)

(72) Inventors: John M. Hauck, Bridgman, MI (US); James W. Barringham, JR., Thornleigh (AU)

(73) Assignee: LECO CORPORATION, St. Joseph, MI (US)

(21) Appl. No.: 13/799,020

(22) Filed: Mar. 13, 2013

(51) Int. Cl. G06K 9/36

(52) U.S. Cl. CPC G06K 9/36
USPC 348/86; 382/274

(57) ABSTRACT

An indentation hardness test system is provided that includes: a frame including an attached indenter; a movable stage for receiving a part attached to the frame; a camera; a display; a processor; and a memory subsystem. The processor performs the steps of: (a) capturing images of different portions of the part; (b) for each image, computing an average intensity; (c) computing an average intensity across all images; (d) for each pixel, computing PixelAverageDeltaₙ(x,y) as a function of the raw pixel data and the average pixel intensity of the image frame; (e) for each pixel, computing a correction factor using the average intensity across all images and PixelAverageDeltaₙ(x,y); (f) performing shading correction by adjusting the raw pixel values by corresponding correction factors; and (g) generating a composite image of the part. Steps (b)-(e) may be performed on moving images while not including stationary images in the computations of those steps.

### BACKGROUND OF THE INVENTION

The present invention is generally directed to a test system and, more specifically, to an indentation hardness test system and to an auto-learning shading corrector.

Hardness testing has been found to be useful for material evaluation and quality control of manufacturing processes and research and development endeavors. The hardness of an object, although empirical in nature, can be correlated to tensile strength for many metals and provides an indicator of wear-resistance and ductility of a material. A typical indentation hardness tester utilizes a calibrated machine to force a diamond indenter (of a desired geometry) into the surface of a material being evaluated. The indentation dimension (dimensions) is (are) then measured with a light microscope after load removal. A determination of the hardness of the material under test may then be obtained by dividing the force applied to the indenter by the projected area of the permanent impression made by the indenter.

In general, it is advantageous to be able to view an overview of the test object so that it is possible to determine the best places to perform hardness tests and thus where to form indentations. It is also advantageous to be able to view a close-up of the indentations. Accordingly, the microscopes used on such indentation hardness testers may utilize various magnification objective lenses. Examples of such hardness testers are disclosed in commonly-assigned U.S. Pat. Nos. 6,996,264 and 7,139,422. These particular hardness testers offer the advantage of forming a mosaic image of the test object formed of images captured through a high magnification objective such that the mosaic image has a much higher resolution than would otherwise be obtainable using a low magnification objective through which the entire test object may be viewed.

When capturing an image with any one of the objective lenses, the image may have some inherent shading in the corners of the image and possibly along the edges of the image as well. Such shadowing, also known as vignetting, may be caused from variations in the position of the objective lens relative to a center of illumination. Other sources of shading include imperfections, distortions and contaminants in the optical path. For most operations, such shading does not present any particular problem. However, when a user wishes to incorporate images in a report, particularly a mosaic (or panoptic) image, such shading can introduce artifacts such as stripes into the mosaic image. FIG. 1 shows an example of a mosaic image in which shading has not been corrected. As apparent from FIG. 1, there are various stripes that appear throughout the image.

One approach that has been used to correct for such shading is to manually place a mirror on a stage of the hardness tester and instruct the hardness tester to perform shading correction. In this process, the mirror is assumed to have a uniform brightness over its whole surface such that a processor of the hardness tester may take an image of the surface of the mirror and then determine a correction factor for each pixel location that results in images of uniform intensity. This approach requires periodic manual operation for each objective lens, which takes valuable time from the operator. Events that would require a new shading correction include: replacement of a light bulb and subsequent change in illumination, changes in alignment of the light source, changes in the alignment of the lenses, and new contaminants (dust) in the optical path.

### SUMMARY OF THE INVENTION

According to one aspect of the present invention, an indentation hardness test system is provided for testing hardness of a test object, the system comprising: a frame including an attached indenter; a movable stage for receiving a part attached to the frame; a camera for capturing images of the part; a display; a processor electrically coupled to the movable stage, the camera and the display; and a memory subsystem coupled to the processor. The memory subsystem storing code when executed instructs the processor to perform the steps of: (a) causing the camera to capture a series of magnified image frames of different portions of the part, where each image frame includes raw pixel data for each pixel; (b) for each captured image frame, computing an average pixel intensity of the image frame; (c) computing an average pixel intensity across all captured image frames; (d) for each pixel, computing PixelAverageDeltaₙ(x,y) as a function of the raw pixel data and the average pixel intensity of the image frame; (e) for each pixel, computing and storing a correction factor using the average pixel intensity across all captured image frames as determined in step (c) and PixelAverageDeltaₙ(x,y) as determined in step (d); (f) for each pixel, performing shading correction by adjusting the raw pixel value by a corresponding correction factor as determined in step (e); and (g) generating a composite image of the part on the display, wherein the composite image includes the series of image frames as corrected for shading in step (f) and assembled according to relative positions of the image frames.

According to another aspect of the present invention, a method is provided for generating a composite image of a part with shading correction, comprising the steps of: (a) capturing a series of magnified image frames of different portions of the part, where each image frame includes raw pixel data for each pixel; (b) for each captured image frame, computing an average pixel intensity of the image frame; (c) computing an average pixel intensity across all captured image frames; (d) for each pixel, computing PixelAverageDeltaₙ(x,y) as a function of the raw pixel data and the average pixel intensity of the image frame; (e) for each pixel, computing and storing a correction factor using the average pixel intensity across all captured image frames as determined in step (c) and PixelAverageDeltaₙ(x,y) as determined in step (d); (f) for each pixel, performing shading correction by adjusting the raw pixel value by a corresponding correction factor as determined in step (e); and (g) generating a composite image of the part, wherein the composite image includes the series of image frames as corrected for shading in step (f) and assembled according to relative positions of the image frames.

According to another aspect of the present invention, a non-transitory computer readable medium is provided having stored thereon software instructions that, when executed by a processor, cause the processor to provide a composite image of a part with shading correction, by executing the steps comprising: (a) capturing a series of magnified image frames of different portions of the part, where each image frame includes raw pixel data for each pixel; (b) for each captured image frame, computing an average pixel intensity of the image frame; (c) computing an average pixel intensity across all captured image frames; (d) for each pixel, computing PixelAverageDeltaₙ(x,y) as a function of the raw pixel data and the average pixel intensity of the image frame; (e) for each pixel, computing and storing a correction factor using the average pixel intensity across all captured image frames as determined in step (c) and PixelAverageDeltaₙ(x,y) as determined in step (d); (f) for each pixel, performing shading correction by adjusting the raw pixel value by a corresponding correction factor as determined in step (e); and (g) generating a composite image of the part, wherein the composite image includes the series of image frames as corrected for shading in step (f) and assembled according to relative positions of the image frames.

These and other features, advantages, and objects of the present invention will be further understood and appreciated by those skilled in the art by reference to the following specification, claims, and appended drawings.

### BRIEF DESCRIPTION OF THE DRAWINGS

The present invention will be more fully understood from the detailed description and the accompanying drawings, wherein:

FIG. 1 is a picture of a mosaic image captured by a hardness tester without the use of any shading correction;

FIG. 2 is a perspective view of an exemplary indentation hardness tester, according to one embodiment;

FIG. 3 is a an electrical block diagram of an exemplary indentation hardness test system configured according to one embodiment;

FIG. 4 is a flow chart illustrating a general routine executed by a processor of the indentation hardness test system;

FIG. 5 is a flow chart illustrating a training routine executed by a processor of the indentation hardness test system; and

FIG. 6 is a picture of a mosaic image captured by an indentation hardness tester using shading correction according to embodiments described herein.

### DETAILED DESCRIPTION OF THE PREFERRED EMBODIMENTS

Reference will now be made in detail to the present preferred embodiments, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

The embodiments described herein relate to an indentation hardness test system and a method for performing shading correction. An exemplary indentation hardness test system is first described with reference to FIGS. 2 and 3 followed by a description with reference to FIGS. 4 and 5 of a method of shading correction that may be performed by the indentation hardness test system.

A system according to the various embodiments described herein can be implemented using an indentation hardness test system that includes: a light microscope, a digital camera positioned to collect images through the microscope, an electrically controlled stage capable of moving a test assembly, i.e., an associated part to be tested or a portion of a part mounted in a plastic, in at least two dimensions in a plane perpendicular to the lens of the light microscope, and a processor (or computer system) connected to both the camera and the stage such that the processor can display images acquired by the camera while monitoring and controlling the movements of the stage and its associated part.

FIG. 2 shows a partial perspective view of an exemplary indentation hardness test system according to a first embodiment. The indentation hardness test system 10 includes a frame 20 with an attached motorized turret 14, including objective lenses 16A and 16B, which form a portion of a light microscope, and an indenter 18, e.g., a Knoop or Vickers indenter. It should be appreciated that additional objective lenses may be mounted on the turret 14, if desired. A stage 12 is movably attached to the frame 20 such that different areas of a test assembly 22, which is attached to the stage 12, may be inspected.

FIG. 3 depicts an exemplary electrical block diagram of various electrical components that may be included within the definition of the test system 10. As is shown, a processor 40 is coupled to a memory subsystem 42, which may be a non-transitory computer readable medium, an input device 44 (e.g., a joystick, a knob, a mouse and/or a keyboard) and a display 46. A frame grabber 48, which is coupled between the processor 40 and a camera 52, functions to capture frames of digital data provided by the camera 52. The camera 52 may, for example, provide an RS-170 video signal to the frame grabber 48 that is digitized at a rate of 30 Hz. The processor 40 is also coupled to and controls a turret motor 54 to properly and selectively position the objective lenses 16A and 16B and the indenter 18 (e.g., a diamond tipped device), as desired. It should be appreciated that additional indenters may also be located on the turret 14, if desired. The processor 40 is also coupled to stage motors (e.g., three stage motors that move the stage in three dimensions) 56 and provides commands to the stage motors 56 to cause the stage to be moved in two or three dimensions for image capture and focusing, as desired. The stage motors 56 also provide position coordinates of the stage that are, as is further discussed below, correlated with the images provided by the camera 52. The position coordinates of the stage may be provided by, for example, encoders associated with each of the stage motors 56, and may, for example, be provided to the processor 40 at a rate of about 30 Hz via an RS-232 interface. Alternatively, the processor 40 may communicate with a separate stage controller that also includes its own input device, e.g., a joystick. The processor 40, the memory subsystem 42, the input device 44 and the display 46 may be incorporated within a personal computer (PC) as shown in FIG. 2. In this case, the frame grabber 48 takes the form of a card that plugs into a motherboard associated with the processor 40. As used herein, the term processor may include a general purpose processor, a microcontroller (i.e., an execution unit with memory, etc., integrated within a single integrated circuit), an application specific integrated circuit (ASIC), a programmable logic device (PLD) or a digital signal processor (DSP).

Additional details of the system described above and the general operation in capturing images and performing indentation hardness testing are described in commonly-assigned U.S. Pat. Nos. 6,996,264 and 7,139,422, the entire disclosures of which are incorporated herein by reference.

The method for performing automatic shading correction is described herein as being implemented by processor 40 using images captured by camera 52. This method may be a subroutine executed by any processor, and thus this method may be embodied in a non-transitory computer readable medium having stored thereon software instructions that, when executed by a processor, cause the processor to provide a composite image of a part with shading correction, by executing the steps of the method described below. In other words, aspects of the inventive method may be achieved by software stored on a non-transitory computer readable medium or software modifications or updates to existing software residing in a non-transitory computer readable medium. Such a non-transitory computer readable medium may include, but is not limited to, any form of computer disk, tape, integrated circuit, ROM, RAM, flash memory, etc., regardless of whether it is located on a portable memory device, a personal computer, tablet, laptop, smartphone, Internet or network server, or dedicated device such as the above-described indentation hardness tester.

The method for performing automatic shading correction is described below with respect to FIGS. 4 and 5. FIG. 4 shows a flow chart illustrating one example of a main routine of the method whereas FIG. 5 shows a flow chart illustrating one example of a training routine that may be utilized. The method generally includes the steps of: (a) capturing a series of magnified image frames of different portions of the part, where each image frame includes raw pixel data for each pixel; (b) for each captured image frame, computing an average pixel intensity of the image frame; (c) computing an average pixel intensity across all captured image frames; (d) for each pixel, computing PixelAverageDeltaₙ(x,y) as a function of the raw pixel data and the average pixel intensity of the image frame; (e) for each pixel, computing and storing a correction factor using the average pixel intensity across all captured image frames as determined in step (c) and PixelAverageDeltaₙ(x,y) as determined in step (d); (f) for each pixel, performing shading correction by adjusting the raw pixel value by a corresponding correction factor as determined in step (e); and (g) generating a composite image of the part, wherein the composite image includes the series of image frames as corrected for shading in step (f) and assembled according to relative positions of the image frames.

This method improves upon the prior method using a mirror in that it eliminates the need to use a mirror and manual initiate a shading correction routine and allows shading correction to be performed on the fly. The premise is that, but for any shading to be corrected, all of the pixels of the imager will be exposed to the same levels of light when averaged over many different images. Thus, from a large sample from which the averages are taken, shading corrections may be obtained that are similar to those obtained using a mirror but without requiring the mirror or the need to perform a separate shading correction routine.

As shown in FIG. 4, the main routine begins with the capture of an image frame in step 100 using camera 52 and a selected objective lens 16A,16B. Next, processor 40 determines in step 102 whether the image is moving. This may be determined by monitoring movement of stage 12 via stage motors 56 or by determining whether the image is different from the prior image. If the image is not moving, processor 40 returns to step 100 and obtains the next image from camera 52 via frame grabber 48. Processor 40 loops through steps 100 and 102 until such time that a captured image is moving, in which case processor 40 proceeds to step 104 where it determines if the system has been trained for the selected objective lens 16A,16B. This determination may be made by checking the status of a “trained” flag, which is set upon completion of sufficient training as explained further below. In addition to the criterion of whether the image is moving, processor 40 may also compare average intensities within the image frame to that of other image frames used for training. If the current image frame has an average intensity that is not sufficiently close in value to the averages of the other image frames, the current image frame may be discarded from consideration for purposes of training, but would still be viable for correction assuming enough training image frames had already been collected.

If the system has not been trained for the selected lens, processor 40 executes a training routine in step 106. Otherwise, if the system has been trained for the selected lens, processor 40 performs shading correction by multiplying the raw pixel values for the captured image frame by previously computed correction factors corresponding to each pixel location of the captured image. The correction factors are computed during the training routine 106, which is described below with reference to FIG. 5.

Once processor 40 has performed shading correction on each pixel of the captured image frame, it adds the corrected image to a composite panoptic image in step 110. Processor 40 then returns to step 100 to process the next captured image frame.

In the example shown in FIG. 4, when processor 40 completes the training routine 106, it may then add the image captured in step 100 to the panoptic image in step 110 without first performing shading correction on the image. This may be the case when training is not yet complete such that the correction factors have not yet been computed over a number of image frames so as to establish a sufficient level of confidence. It should be appreciated, however, that the processor 40 may be programmed instead to not add images to the panoptic image unless training is complete and shading correction is first performed on the image. Still yet other alternatives for the formation of the panoptic image are described below.

Having described the general routine shown in FIG. 4, reference is now made to FIG. 5, which shows the training routine used to compute the shading correction factors. For each image frame n captured in step 100, there is raw pixel data Pixelₙ(x,y) for each pixel location (0,0) through (X,Y), where Y is the total number of rows of pixels and X is the total number of columns of pixels within the image frame. From this raw pixel data Pixelₙ(x,y), an average pixel intensity FrameAverageₙ is computed for that image frame (step 120) as follows:

$${FrameAverage}_{n} = \frac{{Σ}_{{0 \leq x < X}_{0 \leq y < Y}} {Pixel}_{n} ( x , y )}{X * Y} .$$

A running average pixel intensity across all captured images FrameHistoricAverageₙ may then be computed (step 122) using the following equation:

$${FrameHistoricAverage}_{n} = \frac{{\sum }_{i = 1 … n} {FrameAverage}_{i}}{n} .$$

It should be noted, however, that a weighted average could also be used to compute FrameHistoricAverageₙ as could an infinite impulse response (IIR) filter.

Next, the difference PixelDeltaₙ(x,y) between each pixel of the n^{th} frame and the average pixel intensity FrameAverageₙ for that frame is computed (step 124) as follows:

PixelDeltaₙ(x,y)=Pixelₙ(x,y)−FrameAverageₙ.

Then, for each pixel, a running average of the differences computed above (PixelAverageDeltaₙ(x,y)) is computed (step 126) as follows:

$${PixelAverageDelta}_{n} ( x , y ) = \frac{{\sum }_{i = 1. . n} {PixelDelta}_{n} ( x , y )}{n}$$

$$or$$

$${PixelAverageDelta}_{n} ( x , y ) = \frac{{\sum }_{i = 1. . n}^{ } ( {Pixel}_{n} ( x , y ) - {FrameAverage}_{n} )}{n} .$$

It should be noted that, in lieu of steps 124 and 126, PixelAverageDeltaₙ(x,y) could alternatively be computed by averaging the value of each corresponding raw pixel Pixelₙ(x,y) across all n frames to obtain a value PixelAverageₙ(x,y) for each pixel and then subtracting from FrameHistoricAverageₙ as follows:

$${PixelAverageDelta}_{n} ( x , y ) = {PixelAverage}_{n} ( x , y ) - {FrameHistoricAverage}_{n} , \\ or$$

$${PixelAverageDelta}_{n} ( x , y ) = \frac{{\sum }_{i = 1. . n} {Pixel}_{i} ( x , y )}{n} - {FrameHistoricAverage}_{n} .$$

Thus, either way, processor 40 computes PixelAverageDeltaₙ(x,y) as a function of the raw pixel data Pixelₙ(x,y) and the average pixel intensity of the image frame FrameAverageₙ.

A correction factor CorrectionFactorₙ(x,y) for each pixel of the n^{th} frame may then be computed (step 128) as follows:

$${CorrectionFactor}_{n} ( x , y ) = \frac{{FrameHistoricAverage}_{n}}{{FrameHistoricAverage}_{n} + {PixelAverageDelta}_{n} ( x , y )} .$$

Processor 40 then determines in step 130 if the number n of image frames has reached a threshold number N that represents a sufficient number of image frames having been processed so as to provide a sufficient level of confidence in the correction factors. As an example, N may be about 500 frames. Thus, if n>N, processor 40 sets a status of a “trained” flag as being trained for the selected objective lens in step 132. Otherwise, processor 40 ends the training routine without changing the status of the “trained” flag. It should be appreciated that the number of frames N may be varied depending upon operator preference.

If the training is complete, processor 40 may, upon exiting the training routine, return to step 108 in FIG. 4 to perform shading correction on the captured image. Using the above parameters, processor 40 may compute a corrected pixel value CorrectedPixelₙ(x,y) for each pixel of the n^{th} frame (step 108) using the following equation:

CorrectedPixelₙ(x,y)=Pixelₙ(x,y)×CorrectionFactorₙ(x,y).

It should be noted that the correction factor may alternatively be computed as an offset for each pixel and added or subtracted from the raw pixel data.

As noted above, processor 40 may begin to build the panoptic image using captured images that have not been corrected for shading and then use corrected images once training is complete. To determine the relative location of each image, processor 40 may obtain stage coordinates for each captured image frame and assemble the image frames based upon the associated stage coordinates.

FIG. 6 shows a panoptic image generated using the above-described shading correction. As evident from a comparison with FIG. 1, the artifacts of FIG. 1 are no longer present.

Processor 40 may alternatively be configured to use only images that have undergone shading correction. As still yet another alternative, processor 40 may begin to build the panoptic image with uncorrected images and then once training is complete, go back and correct those images using the correction factors. If processor 40 uses some uncorrected images, it may nevertheless go back and replace uncorrected images with corrected images that are subsequently captured of the same portion of the part and subjected to shading correction. Alternatively, processor 40 could superimpose corrected images over uncorrected images regardless of whether the images are of the same exact location on the part. As yet still another alternative, processor 40 may be configured to allow training to go on indefinitely. Training can also be cleared at any time, which causes n to be reset to zero.

In addition to the foregoing, either an additional camera or objective lens may be provided in the indentation hardness test system to capture an overview image of the entirety of the part. This overview image may be used as a starting point of the panoptic image. Previously, a gray shaded area was used to represent the part in an enlarged simulated image of the part with the magnified images added (i.e., superimposed) as they were captured. By starting with an actual overview image of the part and superimposing magnified images as they are captured, detail may be added to the overview image that otherwise would not have been present. Further, the actual overview image of the part provides a much more informative image to start with than a simulated image, as was used previously.

Although the above embodiments have been described with reference to an indentation hardness test system, it will be appreciated by those skilled in the art that the method of shading correction may be used for any panoptic mosaic image even using images captured using a conventional still or video camera.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. An indentation hardness test system for testing hardness of a test object, the system comprising:
a frame including an attached indenter;
a movable stage for receiving a part attached to the frame;
a camera for capturing images of the part;
a display;
a processor electrically coupled to the movable stage, the camera and the display; and
a memory subsystem coupled to the processor, the memory subsystem storing code that when executed instructs the processor to perform the steps of:
(a) causing the camera to capture a series of magnified image frames of different portions of the part, where each image frame includes raw pixel data for each pixel;
(b) for each captured image frame, computing an average pixel intensity of the image frame;
(c) computing an average pixel intensity across all captured image frames;
(d) for each pixel, computing PixelAverageDeltaₙ(x,y) as a function of the raw pixel data and the average pixel intensity of the image frame;
(e) for each pixel, computing and storing a correction factor using the average pixel intensity across all captured image frames as determined in step (c) and PixelAverageDeltaₙ(x,y) as determined in step (d);
(f) for each pixel, performing shading correction by adjusting the raw pixel value by a corresponding correction factor as determined in step (e); and
(g) generating a composite image of the part on the display, wherein the composite image includes the series of image frames as corrected for shading in step (f) and assembled according to relative positions of the image frames.

2. The indentation hardness test system of claim 1, wherein step (a) of capturing a series of magnified image frames includes obtaining, for each image frame n, raw pixel data Pixelₙ(x,y) for each pixel location (0,0) through (X,Y), where X is a total number of rows of pixels and Y is a total number of columns of pixels within the image frame.

3. The indentation hardness test system of claim 2, wherein, in step (b), the average pixel intensity FrameAverageₙ for each image frame n is computed as follows:
$${FrameAverage}_{n} = \frac{{\sum }_{0 \leq x < X \\ 0 \leq y < Y} {Pixel}_{n} ( x , y )}{X * Y} .$$

4. The indentation hardness test system of claim 3, wherein, in step (c), the average pixel intensity across all captured image frames FrameHistoricAverageₙ is computed using the following equation:
$${FrameHistoricAverage}_{n} = \frac{{\sum }_{i = 1. . n} {FrameAverage}_{i}}{n} .$$

5. The indentation hardness test system of claim 4, wherein, in step (d), PixelAverageDeltaₙ(x,y) is computed for each pixel as follows:
$${PixelAverageDelta}_{n} ( x , y ) = \frac{{\sum }_{i = 1. . n} {PixelDelta}_{n} ( x , y )}{n}$$
where a difference PixelDeltaₙ(x,y) between the raw pixel data Pixelₙ(x,y) for each pixel of the n^{th} image frame and the average pixel intensity FrameAverageₙ for that image frame is determined as follows:
PixelDeltaₙ(x,y)=Pixelₙ(x,y)−FrameAverageₙ.

6. The indentation hardness test system of claim 5, wherein, in step (e), the correction factor CorrectionFactorₙ(x,y) is computed for each pixel of the n^{th} image frame as follows:
$${CorrectionFactor}_{n} ( x , y ) = \frac{{FrameHistoricAverage}_{n}}{{FrameHistoricAverage}_{n} + {PixelAverageDelta}_{n} ( x , y )} .$$

7. The indentation hardness test system of claim 6, wherein step (f) further includes computing a corrected pixel value CorrectedPixelₙ(x,y) for each pixel of the n^{th} image frame by:
CorrectedPixelₙ(x,y)=Pixelₙ(x,y)×CorrectionFactorₙ(x,y).

8. The indentation hardness test system of claim 1, wherein the code stored in the memory subsystem, when executed, instructs the processor to perform the step of: obtaining associated stage coordinates for each of the captured image frames, wherein the composite image of the part is generated by assembling the captured image frames according to the associated stage coordinates.

9. The indentation hardness test system of claim 1, wherein steps (b)-(e) are only performed on image frames that are detected as moving.

10. A method for providing a composite image of a part with shading correction, comprising the steps of:
(a) capturing a series of magnified image frames of different portions of the part, where each image frame includes raw pixel data for each pixel;
(b) for each captured image frame, computing an average pixel intensity of the image frame;
(c) computing an average pixel intensity across all captured image frames;
(d) for each pixel, computing PixelAverageDeltaₙ(x,y) as a function of the raw pixel data and the average pixel intensity of the image frame;
(e) for each pixel, computing and storing a correction factor using the average pixel intensity across all captured image frames as determined in step (c) and PixelAverageDeltaₙ(x,y) as determined in step (d);
(f) for each pixel, performing shading correction by adjusting the raw pixel value by a corresponding correction factor as determined in step (e); and
(g) generating a composite image of the part, wherein the composite image includes the series of image frames as corrected for shading in step (f) and assembled according to relative positions of the image frames.

11. The method of claim 10, wherein step (a) of capturing a series of magnified image frames includes obtaining, for each image frame n, raw pixel data Pixelₙ(x,y) for each pixel location (0,0) through (X,Y), where X is a total number of rows of pixels and Y is a total number of columns of pixels within the image frame.

12. The method of claim 11, wherein, in step (b), the average pixel intensity FrameAverageₙ for each image frame n is computed as follows:
$${FrameAverage}_{n} = \frac{{\sum }_{0 \leq x < X \\ 0 \leq y < Y} {Pixel}_{n} ( x , y )}{X * Y} .$$

13. The method of claim 12, wherein, in step (c), the average pixel intensity across all captured image frames FrameHistoricAverageₙ is computed using the following equation:
$${FrameHistoricAverage}_{n} = \frac{{\sum }_{i = 1. . n} {FrameAverage}_{i}}{n} .$$

14. The method of claim 13, wherein, in step (d), PixelAverageDeltaₙ(x,y) is computed for each pixel as follows:
$${PixelAverageDelta}_{n} ( x , y ) = \frac{{\sum }_{i = 1. . n} {PixelDelta}_{n} ( x , y )}{n}$$
where a difference PixelDeltaₙ(x,y) between the raw pixel data Pixelₙ(x,y) for each pixel of the n^{th} image frame and the average pixel intensity FrameAverageₙ for that image frame is determined as follows:
PixelDeltaₙ(x,y)=Pixelₙ(x,y)−FrameAverageₙ.

15. The method of claim 14, wherein, in step (e), the correction factor CorrectionFactorₙ(x,y) is computed for each pixel of the n^{th} image frame as follows:
$${CorrectionFactor}_{n} ( x , y ) = \frac{{FrameHistoricAverage}_{n}}{{FrameHistoricAverage}_{n} + {PixelAverageDelta}_{n} ( x , y )} .$$

16. The method of claim 15, wherein step (f) further includes computing a corrected pixel value CorrectedPixelₙ(x,y) for each pixel of the n^{th} image frame by:
CorrectedPixelₙ(x,y)=Pixelₙ(x,y)×CorrectionFactorₙ(x,y).

17. The method of claim 10, wherein steps (b)-(e) are only performed on image frames that are detected as moving.

18. A non-transitory computer readable medium having stored thereon software instructions that, when executed by a processor, cause the processor to provide a composite image of a part with shading correction, by executing the steps comprising:
(a) capturing a series of magnified image frames of different portions of the part, where each image frame includes raw pixel data for each pixel;
(b) for each captured image frame, computing an average pixel intensity of the image frame;
(c) computing an average pixel intensity across all captured image frames;
(d) for each pixel, computing PixelAverageDeltaₙ(x,y) as a function of the raw pixel data and the average pixel intensity of the image frame;
(e) for each pixel, computing and storing a correction factor using the average pixel intensity across all captured image frames as determined in step (c) and PixelAverageDeltaₙ(x,y) as determined in step (d);
(f) for each pixel, performing shading correction by adjusting the raw pixel value by a corresponding correction factor as determined in step (e); and
(g) generating a composite image of the part, wherein the composite image includes the series of image frames as corrected for shading in step (f) and assembled according to relative positions of the image frames.

19. The non-transitory computer readable medium of claim 18, wherein step (a) of capturing a series of magnified image frames includes obtaining, for each image frame n, raw pixel data Pixelₙ(x,y) for each pixel location (0,0) through (X,Y), where X is a total number of rows of pixels and Y is a total number of columns of pixels within the image frame.

20. The non-transitory computer readable medium of claim 19, wherein, in step (b), the average pixel intensity FrameAverageₙ for each image frame n is computed as follows:
$${FrameAverage}_{n} = \frac{{\sum }_{0 \leq x < X \\ 0 \leq y < Y} {Pixel}_{n} ( x , y )}{X * Y} .$$

21. The non-transitory computer readable medium of claim 20, wherein, in step (c), the average pixel intensity across all captured image frames FrameHistoricAverageₙ is computed using the following equation:
$${FrameHistoricAverage}_{n} = \frac{{\sum }_{i = 1. . n} {FrameAverage}_{i}}{n} .$$

22. The non-transitory computer readable medium of claim 21, wherein, in step (d), PixelAverageDeltaₙ(x,y) is computed for each pixel as follows:
$${PixelAverageDelta}_{n} ( x , y ) = \frac{{\sum }_{i = 1. . n} {PixelDelta}_{n} ( x , y )}{n}$$
where a difference PixelDeltaₙ(x,y) between the raw pixel data Pixelₙ(x,y) for each pixel of the n^{th} image frame and the average pixel intensity FrameAverageₙ for that image frame is determined as follows:
PixelDeltaₙ(x,y)=Pixelₙ(x,y)−FrameAverageₙ.

23. The non-transitory computer readable medium of claim 22, wherein, in step (e), the correction factor CorrectionFactorₙ(x,y) is computed for each pixel of the n^{th} image frame as follows:
$${CorrectionFactor}_{n} ( x , y ) = \frac{{FrameHistoricAverage}_{n}}{{FrameHistoricAverage}_{n} + {PixelAverageDelta}_{n} ( x , y )} .$$

24. The non-transitory computer readable medium of claim 23, wherein step (f) further includes computing a corrected pixel value CorrectedPixelₙ(x,y) for each pixel of the n^{th} image frame by:
CorrectedPixelₙ(x,y)=Pixelₙ(x,y)×CorrectionFactorₙ(x,y).

25. The non-transitory computer readable medium of claim 18, wherein steps (b)-(e) are only performed on image frames that are detected as moving.
